(19) United States
(12) Patent Application Publication
(10) Pub. No.: US 2010/0154300 A1
(43) Pub. Date: Jun. 24, 2010

(54) Hydroponics plant growing assembly

(76) Inventor: John C. Wiersma, Lake Elsinore, CA (US)

Correspondence Address: ALBERT O COTA, 5460 WHITE OAK AVE, SUITE A-331, ENCINO, CA, 91316, US

(21) Appl. No.: 12/317,234

(22) Filed: Dec. 22, 2008

(51) Int. Cl. A01G 31/02; A01G 31/00

(52) U.S. Cl. 47/64; 47/63; 47/41.12

(57) ABSTRACT

A hydroponics plant growing assembly (10) that is comprised of a plant-root expansion structure (12), a moisture retaining upper pad (26), a moisture retaining lower pad (48), a structure and pads sleeve (62) and a structure and pads retaining enclosure (72). The upper and lower pads (26,48) are dimensioned to be placed respectively over and under the structure (12). The sleeve (62) is dimensioned to be placed over the structure and the pads to prevent mineralized water that is poured into the upper pad (26) from spilling over the sides of the upper pad (26) and the structure (12). The enclosure (72) includes a plurality of trays (76) that are each dimensioned to receive and secure the expansion structure (12) with the attached upper and lower pads (26,48).

### TECHNICAL FIELD

The invention generally pertains to indoor plant growing assemblies, and more particularly to a hydroponics plant growing assembly that includes a plant-root expansion structure which is located between an upper and a lower moisture retaining pad.

### BACKGROUND ART

Plant physiology researchers discovered in the 19^{th} century that plants absorb essential mineral nutrients as inorganic ions in water. Under natural conditions, soil acts as a mineral nutrient reservoir, however the soil itself is not an essential element to plant growth. When the mineral nutrients in the soil dissolve in water, the plant roots are able to absorb the water. When the required mineral nutrients are introduced into a plant's water supply artificially, soil is no longer required for the plant to grow. Almost any terrestrial plant will grow with hydroponics.

Today, hydroponics is an established branch of agronomic science. Progress has been rapid, and results obtained in various countries have proved it to be thoroughly practical and to have very definite advantages over conventional methods of horticulture. The two chief merits of the soil-less cultivation of plants are first, higher plant yields, and second, the fact that hydroponics can be used in places where ordinary agriculture or gardening is impossible. For example, people living in urban environments, without gardens, can grow fresh vegetables and fruits in window boxes or on roof-tops.

A search of the prior art did not disclose any literature or patents that read directly on the claims of the instant invention. However, the following U.S. patents are considered related:

| PATENT NO. | INVENTOR | ISSUED |
|---|---|---|
| 6,016,628 | Schlosser | 25 Jan. 2000 |
| 5,410,840 | Loesken | 2 May 1995 |
| 3,755,964 | Rack | 4 Sep. 1973 |

The U.S. Pat. No. 6,016,628 discloses a plant substrate that is in the form of a soil-like mixture for use with a flower box. The substrate mixture is placed into a plastic enclosure that is water-permeable and that is dimensioned to fit into an enclosed section of the flower box.

The U.S. Pat. No. 5,410,840 discloses a process for producing a support-free vegetation mat, which is particularly useful for roof-top gardening and the like. An earth substrate and plants with roots are used in combination with the vegetation mat, which is designed to be cultivated and to be transported in a stackable, dimensionally stable form. Only at the time of laying the vegetation mat is the mat slit-off and separated from the substrate.

The U.S. Pat. No. 3,755,964 discloses a skeletal structure that forms a wrapper and has thin walls which define a plurality of chambers. The structure is made of an elastic porous foam through which plants can grow. A soil-like plant substrate material is placed in the chambers to prevent the substrate material from escaping from the plurality of the chambers.

For background purposes and as indicative of the art to which the invention relates, reference may be made to the following remaining patents found in the search:

| PATENT NO. | INVENTOR | ISSUED |
|---|---|---|
| 5,421,123 | Sakate et al | 6 Jun. 1995 |

### DISCLOSURE OF THE INVENTION

The hydroponics plant growing assembly (HPGA) is utilized to grow and maintain plants that are placed in a soil-less structure. When water containing mineral nutrients is poured into the soil-less structure the plants flourish. In its basic design configuration, the HPGA is comprised of:

A. A plant-root expansion structure comprising an upper surface having at least one plant-stem insertion cavity, a lower surface and four sides,

B. A moisture retaining upper pad having an upper surface and a lower surface, and that is dimensioned to be placed over and to encompass the upper surface of the structure. The upper pad further has a plant-stem insertion bore that is concentrically aligned with the plant-stem insertion cavity located on the structure, and

C. A moisture retaining lower pad having an upper surface and a lower surface, and that is dimensioned to be placed under and to encompass the lower surface of the structure.

In the preferred embodiment the upper and lower surface of the expansion structure, in combination with the four sides, form a cube. Additionally, the sides of the structure can also be extended to accommodate a particular specie of plant. The structure is made of a material such as rockwool mineral fibers, which absorbs the water and mineral combination that allows the plants to grow.

The moisture retaining upper and lower pads are made of a fibrous material that evenly absorbs and distributes the mineral-rich water prior to passing the water into the expansion structure where the water interfaces with the plant roots. The preferred material used to make the pads is human hair, however other fibrous materials can also be utilized.

To augment the utility of the HPGA, a structure and pads sleeve, and a structure and pads retaining enclosure can be utilized. The sleeve is inserted around the structure and the two pads to prevent the applied fluid from spilling over the sides of the structure and the upper pad, and to maintain the structural integrity of the pads and the structure. The enclosure provides a means for rigidly retaining and maintaining a plurality of HPGAs in a stable and vertical position.

In view of the above disclosure the primary object of the invention is to provide a HPGA that allows a convenient and healthy way of growing various plants in a soil-less environment.

In addition to the primary object of the invention it is also an object of the invention to provide a HPGA that:
can be made in various shapes and dimensions to accommodate various sizes of plants,
produces a higher plant yield,
conserves water and mineral nutrients,
allows plant growth to occur where ordinary agriculture or gardening is difficult or impossible,
allows faster plant growth with relative freedom from soil diseases,
allows some plants to be grown out of season, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a side elevational cross-sectional view of the hydroponics plant growing assembly showing the relative locations of a plant-root expansion structure, a moisture retaining upper pad, a moisture retaining lower pad, a structure and pads sleeve, and a structure and pads retaining enclosure.

FIG. 2 is a top plan and cross-sectional view of the assembly.

FIG. 3 is a bottom plan and cross-sectional view of the lower pad and the sleeve.

FIG. 4 is a perspective view of the plant-root expansion structure configured as a cube.

FIG. 5 is a perspective view of a plant-root expansion structure having elongated sides.

FIG. 6 is a perspective view of the moisture retaining upper pad showing the relative locations of a plant-stem insertion bore and a plant-stem insertion slit.

FIG. 7 is a perspective view of the moisture retaining lower pad.

FIG. 8 is a top plan view of a structure and pads retaining enclosure having four trays, wherein into one of the trays is inserted a structure and pads.

FIG. 9 is a side elevational upper-sectional view of a tray having a plurality of upper extending protrusions.

### BEST MODE FOR CARRYING OUT THE INVENTION

The best mode for carrying out the invention is presented in terms of a preferred embodiment for a hydroponics plant growing assembly 10 (HPGA 10), which allows plants to be grown in a soil-less environment. The HPGA 10 is designed to absorb and distribute water containing mineral nutrients into the soil-less structure that maintains the plant roots.

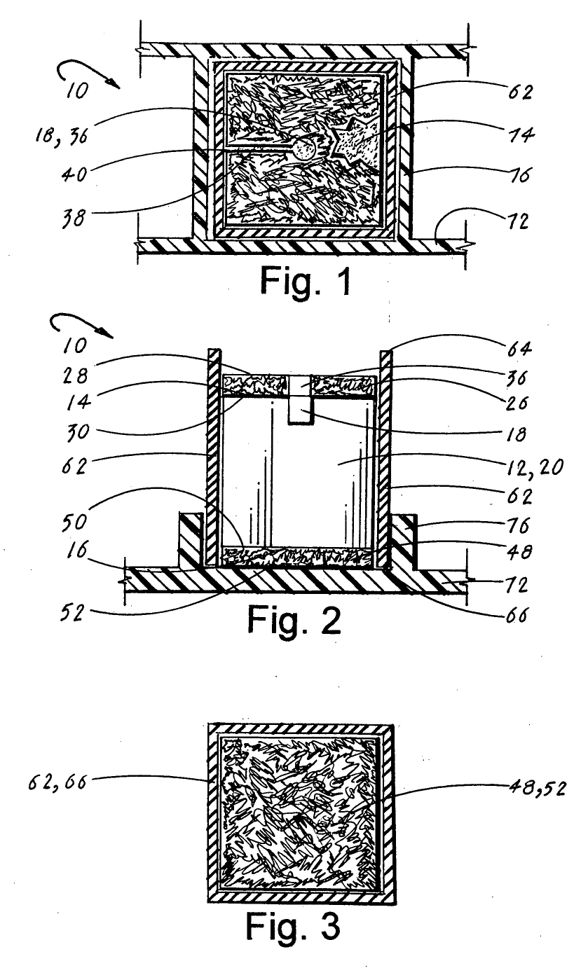

The preferred embodiment of the HPGA 10, as shown in FIGS. 1-9, is comprised of five major elements: a plant-root expansion structure 12, a moisture retaining upper pad 26, a moisture retaining lower pad 48, a structure and pads sleeve 62, and a structure and pads retaining enclosure 72.

The plant-root expansion structure 12, as shown in FIGS. 1-5, is comprised of an upper surface 14, a lower surface 16 and four sides 20. The structure 12 is made of an interwoven fibrous material that preferably is comprised of a rockwool mineral fiber. Other fiber materials such as wood fibers, cloth fibers, various biodegradable fibers and mineral wool fibers can also be utilized. The structure, as shown in FIGS. 1-4, has six equal sides that form a cube. Each side measures from 5 to 7-inches (12.7 to 17.78 cm) with sides that measure 6-inches (15.24 cm) preferred. To accommodate some species of plants that have long stems, the structure 12 can be dimensioned with two horizontal sides that measure from 5 to 7-inches (12.7 to 17.78 cm) and four vertical sides that have a height that ranges from 7 to 8-inches (17.78 to 20.32 cm) that form a rectangular structure, as shown in FIG. 5.

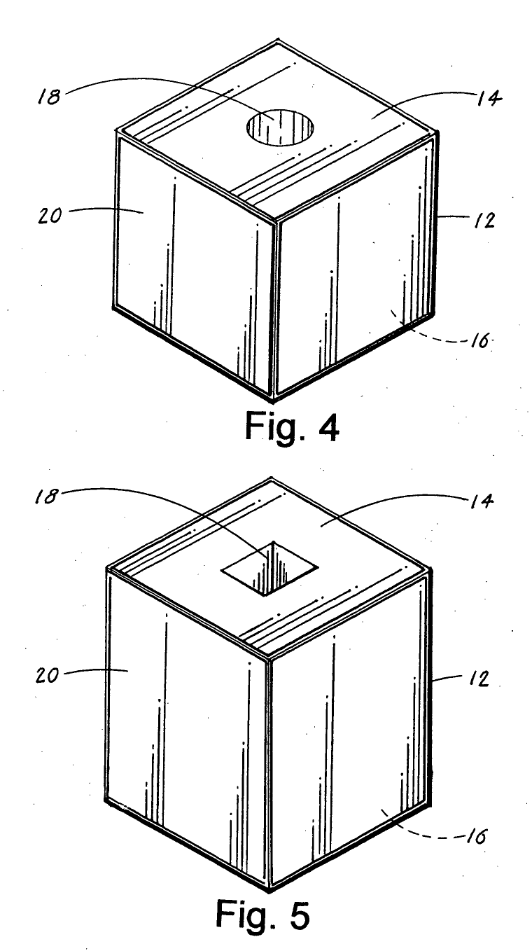

The structure 12 includes at least one plant stem insertion cavity 18 that extends from the upper surface 14 of the structure 12 and that can have a circular shape, as shown in FIGS. 2 and 4, or a square shape as shown in FIG. 5. The circular shape has a diameter that ranges from 1.5 to 3.0-inches (3.81 to 7.62 cm) and a depth that ranges from 1.5 to 3.0-inches (3.81 to 7.62 cm). Likewise, the square shape has sides that range from 1.5 to 3.0-inches (0.381 to 7.62 cm) and a depth that ranges from 1.5 to 3.0-inches (3.81 to 7.62 cm). The depth of the cavity 18 depends on the length of the plant stem that is to be inserted into the cavity 18. For most plants, a maximum depth of 3.0-inches (7.62 cm) is sufficient.

The moisture retaining upper pad 26, as shown in FIGS. 1, 2 and 6, is designed and dimensioned to be placed over and to encompass the upper surface 14 of the structure 12. The upper pad 26 includes an upper surface 28, a lower surface 30, a width 32 and a thickness 34. As shown in FIGS. 1 and 2, the lower surface 30 of the upper pad 26 interfaces with the upper surface 14 of the structure 12. The upper pad 26 is made of interwoven fibers that are selected from the group consisting of human hair which is preferred, animal hair, cloth fibers, compressed feather fibers or other biodegradable synthetic fibers. The overall planer dimensions of the upper pad 26 is identical to the planer dimensions of the upper surface 14 of the structure 12 and the pad's thickness can range from 0.25 to 1.0-inches (0.635 to 2.54 cm).

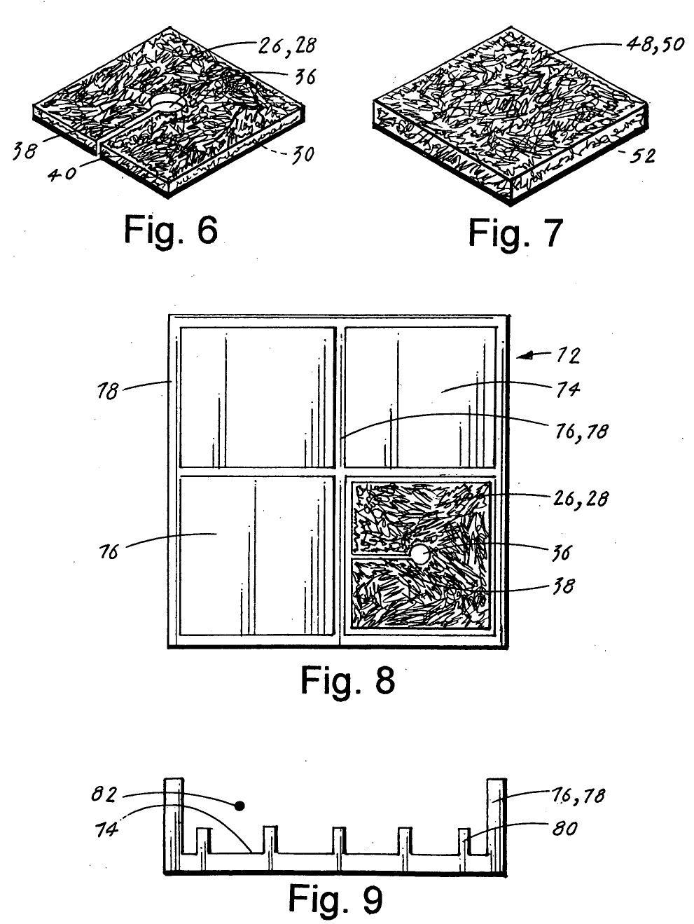

The upper pad 26, as shown in FIGS. 2 and 6, further includes at least one plant stem insertion bore 36 and at least one plant-stem insertion slit 38. The bore 36 is concentrically aligned with the plant-stem insertion cavity 18 that is located on the upper surface 14 of the structure 12. The plant-stem insertion slit 38 extends radially from the plant stem insertion bore 36 to an edge 40 of the upper pad 26. When inserting a plant into the bore 36 and into the cavity 18, the slit 38 can be manually separated to allow the plant stem to be horizontally moved to further facilitate the insertion of the plant.

The moisture resistant lower pad 48, as shown in FIGS. 1, 3 and 7, is designed to be placed under and to encompass the lower surface 16 of the structure 12. The lower pad 48 includes an upper surface 50, a lower surface 52, a width 54 and a thickness 56. As shown in FIGS. 1 and 3, the upper surface 50 is dimensioned to interface with the lower surface 16 of the structure 12. The thickness of the lower pad 48 can range from 0.25 to 1.0-inches (0.635 to 2.54 cm). As best shown in FIG. 7, the lower pad 48 differs from the upper pad 26 in that the lower pad 48 does not have a plant-stem insertion bore 36 or a plant-stem insertion slit 38. The material utilized for the lower pad 48 is also selected from the group consisting of the preferred human hair, animal hair, cloth fibers, compressed feather fibers or biodegradable synthetic fibers.

The structure and pads sleeve 62, as shown in FIGS. 1, 2 and 3, includes and upper edge 64 and a lower edge 66, and is dimensioned to be placed over and to 30 encompass the moisture retaining upper pad 26, the plant-root expansion structure 12 and the moisture retaining lower pad 48. When the sleeve is in place the upper edge 64 of the sleeve 62 extends above the upper surface 28 of the upper pad 26 for a distance ranging from 0.5 to 1.5-inches (.127 to 3.81 cm). The sleeve's lower edge 66 is located adjacent to the lower surface 52 of the lower pad 48. The material for the sleeve 62 is selected from the group consisting of plastic, aluminum foil, waxed paper or rubber. The sleeve 62 functions to prevent any liquid poured into the upper pad 26 from spilling over the sides of the upper pad 26 and the structure 12.

The final element that comprises the HPGA 10 is the structure and pads retaining enclosure 72, which includes an enclosed base 74 that surrounds a plurality of trays 76, with each tray having sides 78 that extend upward from the base 74. The trays 76 are each dimensioned to receive and enclose a single structure 12 with the lower pad 48 attached. To further augment the utility of the enclosure 72, a space 82 on the base 74 is created, which is enclosed by the trays 76 and includes a plurality of protrusions 80, as shown in FIGS. 8 and 9. The protrusions 80 allow a space 82 to be created between the base 74 and the lower surface 52 of the lower pad 48. Any residual fluid that drips from the lower pad 48 enters the space 82 and dissipates therefrom. The retaining enclosure 72 is constructed of a material that is selected from the group consisting of wood, moisture-resistant cardboard or plastic.

While the invention has been described in detail and pictorially shown in the accompanying drawings it is not to be limited to such details, since many changes and modifications may be made to the invention without departing from the spirit and the scope thereof Hence, it is described to cover any and all modifications and forms which may come within the language and scope of the claims.

### HYDROPONICS PLANT GROWING ASSEMBLY

### Designation Elements

### For Convenience of the Examiner, Not Part of the Specification

10 Hydroponics Plant Growing Assembly
12 Plant-Root Expansion Structure
14 Upper Surface
16 Lower Surface
18 Plant-Stem Insertion Cavity
20 Four Sides
22
24
26 Moisture Retaining Upper Pad
28 Upper Surface
30 Lower Surface
32 Width
34 Thickness
36 Plant-Stem Insertion Bore
38 Plant-Stem Insertion Slit
40 Pad Edge
42
44
46
48 Moisture Retaining Lower Pad
50 Upper Surface
52 Lower Surface
54 Width
56 Thickness
58
60
62 Structure and Pads Sleeve
64 Upper Edge
66 Lower Edge
68
70
72 Structure & Pads Retain Encl.
74 Enclosed Base
76 Tray
78 Sides
80 Protrusions
82 Space

1. A hydroponics plant growing assembly comprising:
a) a plant-root expansion structure comprising an upper surface having at least one plant-stem insertion cavity, a lower surface and four sides,
b) a moisture retaining upper pad having an upper surface and a lower surface, and that is dimensioned to be placed over and to encompass the upper surface of said structure, wherein said upper pad further having at least one plant-stem insertion bore that is concentrically aligned with the at least one plant-stem insertion cavity located on said structure, and
c) a moisture retaining lower pad having an upper surface and a lower surface, and that is dimensioned to be placed under and to encompass the lower surface of said structure.

2. The assembly as specified in claim 1 wherein said plant-root expansion structure is configured as a cube.

3. The assembly as specified in claim 2 wherein said structure is made of a material that is selected from the group consisting of mineral wool, rockwool mineral fibers, wood fibers, cloth fibers, biodegradable fibers and open-cell foam.

4. The assembly as specified in claim 1 wherein said moisture retaining upper and lower pads are comprised of interwoven fibers that are selected from the group consisting of human hair, animal hair, cloth fibers, compressed feathers and biodegradable synthetic fibers.

5. The assembly as specified in claim 1 further comprising a structure and pads sleeve that is dimensioned to be placed over said moisture retaining upper pad, said plant-root expansion structure and said moisture retaining lower pad, wherein said sleeve comprises:
a) an upper edge that extends above said moisture retaining upper pad, and
b) a lower edge that is adjacent to the lower surface of said moisture retaining lower pad.

6. The assembly as specified in claim 5 wherein said sleeve is made of a moisture-resistant material that is selected from the group consisting of plastic, aluminum foil, waxed paper, and rubber.

7. The assembly as specified in claim 1 further comprising a structure and pads retaining enclosure having a base from where extends upward a plurality of trays that are each dimensioned to accept an upper pad, an expansion structure and a lower pad.

8. A hydroponics plant growing assembly comprising:
a) a plant-root expansion structure having:
(1) an upper surface having a plant-stem insertion cavity,
(2) a lower surface, and
(3) six sides,
b) a moisture retaining upper pad having:
(1) an upper surface,
(2) a lower surface that is placed over and that encompasses the upper surface of said structure,
(3) a width,
(4) a thickness,
(5) a plant-stem insertion bore that is concentrically aligned with the plant-stem insertion cavity located on said structure,
(6) a plant-stem insertion slit that extends radially from the plant-stem insertion bore to an edge of said upper pad,
c) a moisture retaining lower pad having:
(1) an upper surface that is placed under and that encompasses the lower surface of said structure,
(2) a lower surface,
(3) a width,
(4) a thickness,
d) a structure and pads sleeve that is dimensioned to be placed over and. to encompass said moisture retaining upper pad, said plant-root expansion structure and said moisture retaining lower pad, wherein said sleeve comprises:
(1) an upper edge that extends above the upper surface of said moisture retaining upper pad,
(2) a lower edge that is adjacent to the lower surface of said moisture retaining lower pad,
e) a structure and pads retaining enclosure comprising:
(1) an enclosed base, and
(2) a plurality of trays that extend upward from the base, wherein each tray has sides that are dimensioned to encompass a lower pad an expansion structure and an upper pad.

9. The assembly as specified in claim 8 wherein said plant-root expansion structure is made of an interwoven fibrous material that is selected from the group consisting of mineral wool, rockwool mineral fibers, wood fibers, cloth fibers, biodegradable fibers and mineral wool fibers.

10. The assembly as specified in claim 8 wherein each of the six sides of said structure measure from 5 to 7-inches (12.7 to 17.78 cm), wherein the six equal sides define a cube.

11. The assembly as specified in claim 8 wherein said structure has two horizontal sides that each measure from 5 to 7-inches (12.7 to 17.78 cm) and four vertical sides that each have a height that ranges from 7 to 8-inches (17.78 to 20.32 cm) wherein the six sides define a rectangular structure.

12. The assembly as specified in claim 8 wherein the plant stem insertion cavity located on said structure has a circular shape with a diameter that ranges from 1.5 to 3.0-inches (3.81 to 7.62 cm), and a depth that ranges from 1.5 to 3.0-inches (3.81 to 7.62 cm).

13. The assembly as specified in claim 8 wherein the plant stem insertion cavity has a square shape with sides that range from 1.5 to 3.0-inches (3.81 to 7.62 cm), and a depth that ranges from 1.5 to 3.0 inches (3.81 to 7.62 cm).

14. The assembly as specified in claim 8 wherein said moisture retaining upper pad is comprised of interwoven fibers that are selected from the group consisting of human hair, animal hair, cloth fibers, compressed feather fibers and biodegradable synthetic fibers.

15. The assembly as specified in claim 14 wherein the thickness of said moisture retaining upper pad ranges from 0.25 to 1.0-inches (0.635 to 2.54 cm).

16. The assembly as specified in claim 8 wherein said moisture retaining lower pad is comprised of interwoven fibers that are selected from the group consisting of human hair, animal hair, cloth fibers, compressed feather fibers and biodegradable synthetic fibers.

17. The assembly as specified in claim 16 wherein the thickness of said moisture retaining lower pad ranges from 0.25 to 1.0-inches (0.635 to 2.54 cm).

18. The assembly as specified in claim 8 wherein the upper edge of said sleeve extends above the upper surface of said moisture retaining upper pad from 0.5 to 1.5-inches (1.27 to 3.81 cm).

19. The assembly as specified in claim 8 wherein said structure and pads retaining enclosure is constructed of a material that is selected from the group consisting of wood, moisture-resistant cardboard and plastic.

20. The assembly as specified in claim 19 wherein from the base of each said tray extends a plurality of upper extending protrusions that allow a space to be created between the base and the lower surface of said moisture retaining lower pad.
